(19) United States
(12) Patent Application Publication
(10) Pub. No.: US 2007/0250515 A1
(43) Pub. Date: Oct. 25, 2007

(54) Method and system of securing content and destination of digital download via the internet

(76) Inventors: David H. Lea, San Jose, CA (US); Jon Vavrus, Claremont, CA (US); Jay Perkins, Tulsa, OK (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/518,205

(22) Filed: Sep. 11, 2006

Related U.S. Application Data
(60) Provisional application No. 60/793,660, filed on Apr. 21, 2006.

(51) Int. Cl. G06F 17/30; G06F 7/00

(52) U.S. Cl. 707/10; 707/205

(57) ABSTRACT

Methods and system of securing content and a destination of downloaded data may include a remote server comprising an executable file generator module operable to generate a customized file comprising requested map information and a data marker locking the map information to a predetermined end user device. The file generator module is further operable to encrypt the data marker and place a cipher key at a predetermined location in the customized file. The remote server is further operable to provide a download link to a user operating a user computing device operable to download the customized file from the remote server, for subsequent transfer to an end user device. Based upon the contents of the data marker, the end user device is operable to determine whether the downloaded file is intended for that particular end user device.

### FIELD OF THE INVENTION

The present invention relates generally to methods and systems for securing content and destination of digital downloads via the Internet, and more specifically, to downloading map information for use in portable GPS (Global Positioning System) systems.

### BACKGROUND OF THE INVENTION

It is important to be able to update maps and other information to a GPS system because the maps become outdated over time. In the past, these updates have been provided using only CD (compact disk) and SD (secure digital) based products and the purchaser uses a coupon code to unlock the CD or SD card after purchase. The coupon code prevents the CD or SD card from being duplicated, but does not prevent, for example, the SD card from being used on different devices.

Other digital downloads not related to GPS systems use other techniques. For example, iTunes does not have customized downloads, but instead uses a Digital Rights Management System (DRM) which is most likely based on the system registry. Yahoo™ Games on demand uses a video game launcher application to control access. Digital River Software Passport is used to control access to .exe's/.dll's, users must install this prior to using purchased software product.

There is a need for a method and system of securing content and destination of digital download via the Internet for permitting a customer to download maps over the Internet without having to send physical media, such as a CD or an SD card, to the customer without the risk of the customer duplicating the map information or using the map information on a device other than the device for which it was purchased.

### SUMMARY OF THE INVENTION

The present invention substantially fills the needs mentioned above. The present invention provides a method and system for downloading map information over the Internet, whereby the use of the downloaded file is limited to a user determined device selected at a time of purchase.

In one aspect, a method of securing content and destination of digital download to an end user device comprises the steps of logging a user into a remote system comprising a map server, generating on the map server a data marker including an identification number for the end user device, generating on the map server a customized file comprising the generated data marker and a user selected map file, providing a download link for the user; and downloading the customized file.

In one aspect, a remote server comprising at least one processor is configured to perform above actions.

In another aspect, a method of utilizing, on an end user device, downloaded content intended for that end user device, comprises receiving a customized map file from a computing device, comparing information stored in a data marker block of the customized map file with at least a serial number of the end user device, and displaying the map information on the end user device based upon a result of the comparison.

According to another aspect, a portable GPS device is configured to perform the actions performed on the end user device as disclosed above.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a block diagram of an exemplary embodiment of a system for downloading map information for end user portable devices;

FIG. 2 is a block diagram of an end user portable device and an end user computing device according to the system of FIG. 1;

FIG. 3 is a file structure of an exemplary embodiment of a downloadable file locked to a destination user device according to the system of FIG. 1;

FIG. 4 is a block structure of an exemplary data marker comprising the locked file according to the system of FIG. 1;

FIG. 5 is a flowchart for ordering map data from a remote system according to the system of FIG. 1;

FIG. 6 is a flow chart for downloading map data from a remote system to the end user's computing device according to the system of FIG. 1; and

FIG. 7 is a flowchart for locking a user selected map to the user's portable device, according to the system of FIG. 1.

### DETAILED DESCRIPTION OF THE EXEMPLARY EMBODIMENTS

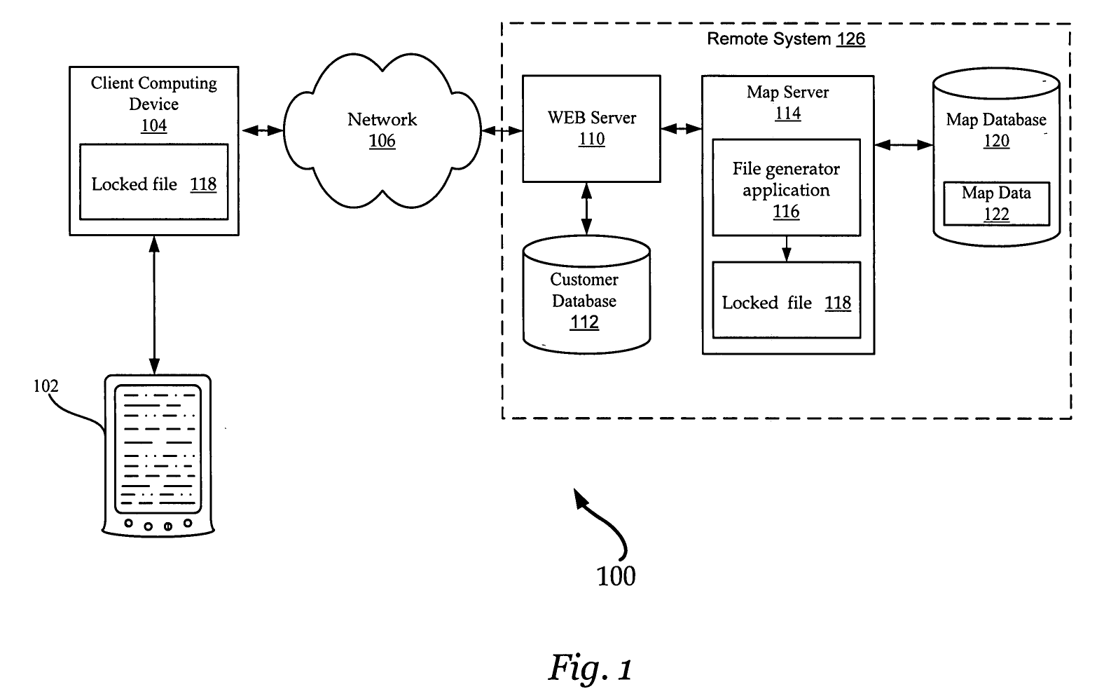

An overall system 100 is depicted in FIG. 1 and includes a remote system 126 that may further comprise a web server 110 connected to a map server 114, and a corporate database comprising customer information 112. A map information database 120 may be associated with the map server 120 and comprises maps and map information 122 that may be purchased by an end user for use on their portable end user device 102.

Selecting and purchasing the map information 122 may be performed online by an end user accessing the remote system 126 via a network 106, i.e., the Internet, using any computing device equipped with a standard web browser and an Internet connection, such as end user computer device 104.

An end user computing device 104, not necessarily the device selecting and purchasing the map information, but one electrically connected to the end user's portable device 102, is operable to communicate with the web server 110 and instruct the map server 114 to create, by means of a file generation module 116, a downloadable file 118 comprising the requested map information but locked to the end user's portable device 102. Once created, the end user computing device 104 is operable to download the locked file 118 and subsequently transfer the map file 118 to the end user's portable device 102.

Upon receiving locked file 118, the end user's portable device 102 is configured to validate the file based upon the encrypted information included within in the transferred file 118. Accordingly, by locking map data 122 to a specific end user portable device 102, system 100 is operable to control the usability of downloaded data.

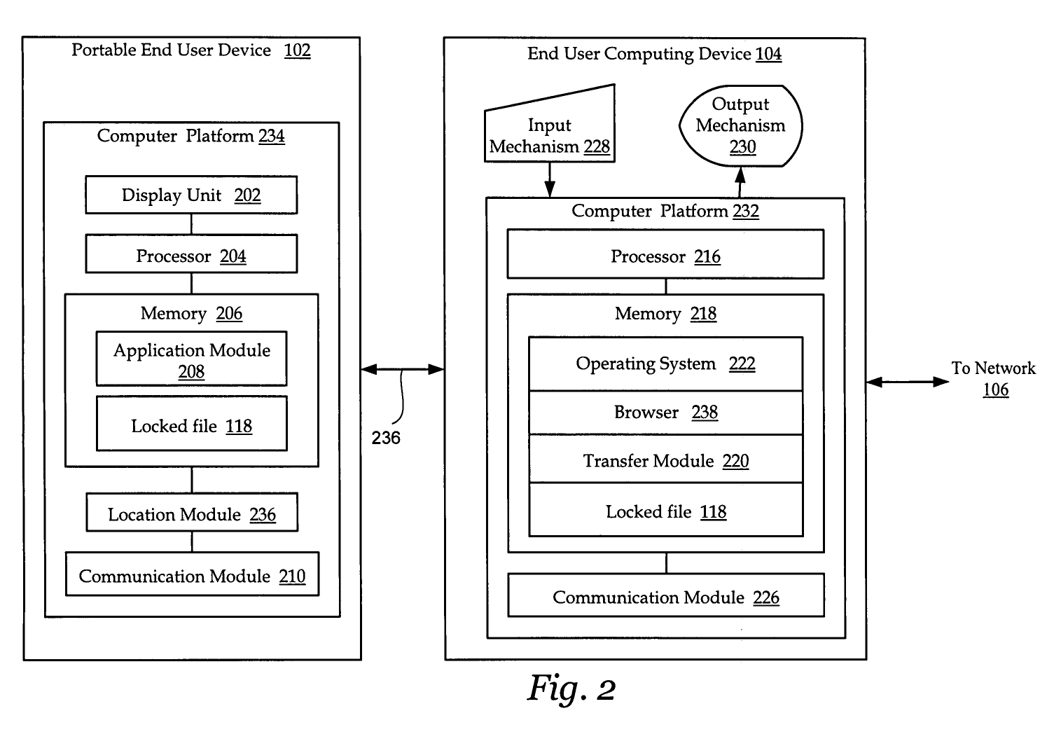

Referring to FIG. 2, the portable end user device 102 may include a computer platform 234 operable to determine and display a position of the portable end user device 102 and display its position on an output display 202 integral to the device 102. The map information displayed on the output display 202 may be based upon information stored on internal and external memory devices, such as CD and SD products. Such information may be downloaded from computer systems, i.e., an end user's computing device 104 that has downloaded or otherwise stored map information retrieved from a remote computing system 126.

Examples of portable end user devices 102 include EXPLORIST devices from the MAGELLAN product series, or GPS units from the MERIDIAN series of GPS devices. Both product series are manufactured by Thales Navigation, headquartered in San Dimas, Calif.

In some aspects, computer platform 234 may include a processing engine 204, a location module 236, and memory 206. Processing engine 204 may comprise an application-specific integrated circuit (ASIC), or other chipset, processor, microprocessor, logic circuit, or other data processing device operable to perform one or more processing functions for the end user device 102, Furthermore, processing engine 204 may include various processing subsystems, embodied in hardware, firmware, software, and combinations thereof, that enable the functionality of the end user device 102, including initiating and maintaining communications, and exchanging data with other networked devices, e.g. end user computing device 104.

In some aspects, portable end user device 102 may comprise a location module 236 that may comprise, in whole or in part, a geographic information system (GIS), such as a tool used to gather, transform, manipulate, analyze, and produce information related to the surface of the earth. In some aspects, such a GIS may include a global positioning system (GPS), such as a satellite navigational system formed by satellites orbiting the earth and their corresponding receivers on the earth. The GPS satellites continuously transmit digital radio signals that contain data on the satellites' location and the exact time to the earth-bound receiver. The satellites are equipped with atomic clocks that are precise, for example, to within a billionth of a second.

Based on this information, the receivers know how long it takes for the signal to reach the receiver on earth. As each signal travels at the speed of light, the longer it takes the receiver to get the signal, the farther away the satellite is located. By knowing how far away a satellite is, the receiver knows that it is located somewhere on the surface of an imaginary sphere centered at the satellite. By using three satellites, GPS can calculate the longitude and latitude of the receiver based on where the three spheres intersect. By using four satellites, GPS can also determine altitude.

Memory 206 may be any type of memory, including read-only memory (ROM), random-access memory (RAM), EPROM, EEPROM, flash memory cells, secondary or tertiary storage devices, such as magnetic media, optical media, tape, or soft or hard disk, whether resident on computer platform 234 or remotely accessible from computer platform 234. An application module 208 resident in memory 206 comprises the program instructions operated upon by the processor 204 to receive the inputs from the location module 236 and display the position of the portable end user device 102 on the display unit 202 based upon map information that has been stored on the device 102.

Application module 208 is further operable to instruct the end user device to receive locked file 118 from the end user's computing device 104, decrypt and validate the downloaded file based upon a predetermined encryption algorithm and cipher key. In one aspect, only files that have been authorized for use on that particular end user device 102 are usable on that device 102.

Still referring to the portable end user device 102, computer platform 234 may further include a communication module 210 operable to send and/or receive signals and/or information to and/or from components within the portable end user device 102 and between the portable end user device and an external device, such as a GPS satellite (not shown) and the end user's computing device 104. For instance, communication module 210 may include one or any combination of input and/or output ports, transmit and receive chain components, transceivers, antenna, etc, i.e., a wired or wireless universal serial bus (USB) port. Communication module 210 may include, but is not limited to, technologies such as a one or any combination of a wireless GPS satellite interface; a serial port, i.e., a universal serial bus (USB) port and a FIREWIRE serial bus interface; an infrared interface; and a short range radio frequency interface, such as a BLUETOOTH technology interface.

Still referring to FIG. 2, in some aspects, the client computing device 104 acts as an intermediary device, to which files purchased from the remote system 126 for subsequent downloaded to an electrically connected portable end user device 102. While in some aspects the client computing device 104 may be a personal computer, the physical attributes of customer computing device 104 are non-limiting. For example, customer computing device 104 may comprise, but is not limited to, at least one of any type of laptop computer, personal computer, mini computer, mainframe computer, terminal, or any computing device either special purpose or general computing device having device resources, e.g., memory, data storage, network connections, output mechanisms, etc., that may be accessible to an application running on a portable end user device 102 connected to the computing device 104.

In some aspects, customer computing device 104 may comprise a processing assembly 216, executing a memory resident operating system, e.g., Linux, Win32, etc. Furthermore, the customer computing device 104 may comprise a memory 218 operable to store application programs, including, but not limited to operating system 222, a standard web browser application 238 operable to connect to web server 110, and a transfer module 220 operable to transfer files to the portable end user device 102.

Furthermore, computer platform 232 may comprise a communications module 226 operable to transmit and receive messages and data to/from the portable end user device 102. Customer computing device 104 may communicate with the portable end user device 102 via any available interface, e.g., serial port, USB, FIREWIRE, BLUETOOTH, infrared, etc.

Customer computing device 104 may further comprise an input mechanism 228, i.e., keyboard, CD reader, etc., and an output mechanism 230, e.g., a display screen such as an LCD screen, interconnected to computer platform 232. The input mechanism 228 and the output mechanism 230 may permit a user to interface with the various application programs stored in memory 218.

Non-limiting, the end user computing device 104 purchasing map file information need not be the customer computing device 104 that downloads the purchased map information for subsequent transfer to the portable end user device 102. In some aspects, the only requirement of a customer computing device 104 to purchase a map file 122 for future download is a web browser application 238 residing in memory 218. Web browser applications are commonly available and may include, but are not limited to Microsoft's INTERNET EXPLORER, Netscape NAVIGATOR, and Mozilla's FIREFOX.

In other aspects, the transfer module 220 may be capable to log directly into the remote system 126, purchase and download map files based upon customer specific account information stored in memory 218. Such information may include account login information, and end user device specific information, including, but not limited to, i.e., model, serial number, date of purchase, etc. Such information may be entered manually via input mechanism 228 and/or automatically received by the client application module 220 when the end user device 102 is connected to the client's external computing device 104.

Regardless of how file 118 is stored in memory 218, the transfer module 220 is configured to communicate with a connected portable end user device 102 in order to push, or have the end user device 102 pull, locked file 118 into the memory 208 of the end user device 102. The transfer module 220 may be downloaded from remote system 126 or loaded into memory via a compact disk supplied along with the portable end user device 102.

Referring back to FIG. 1, network 106 may include any communications network operable, at least in part, for enabling communications between a client's computing device 104 and any device connected to network 106, i.e., web server 110. Further, network 106 may include all network components, and all connected devices that form the network. For example, network 106 may include at least one, or any combination, of: a telephone network; an infrared network such as an Infrared Data Association (IrDA)-based network; a short-range wireless network; a BLUETOOTH technology network; a ZIGBEE protocol network; an ultra wide band (UWB) protocol network; a wideband network, such as a wireless Ethernet compatibility alliance (WECA) network, a wireless fidelity alliance (“Wi-Fi Alliance”) network, and a 802.11 network; a public switched telephone network; a public heterogeneous communications network, such as the Internet; a private communications network; and a land mobile radio network.

Still referring to FIG. 1, in one or more aspects, remote system 126 may comprise a plurality of servers, e.g., web server 110 and map server 114, and place orders for map data 122 purchased by a customer accessing web server 110. The customer may access web server 110 via any browser 232 (FIG. 2) equipped computing device 104 having access to network 106.

Further, there can be additional servers or computer devices associated with remote system 126 that work in concert to provide data in usable formats, and/or a separate layer of control in the data flow between the customer computing device 104 and remote system 126.

Web server 110 and map server 114 may comprise one or more processing engines that may be any combination of processors, including an application-specific integrated circuit (ASIC), a chipset, a processor, a microprocessor, a logic circuit, and any other data processing device. These server processing engines performs one or more processing functions and may execute a module resident on or remotely assessable by the web server 110 and the map server 114 to perform a given function.

Each server may further include a memory not shown for storing data and/or executable instructions, etc. The memory may include, but is not limited to, one or any combination of a read-only memory (ROM), a random-access memory (RAM), an EPROM, an EEPROM, a flash memory cell, a secondary or tertiary storage device, such as magnetic media, optical media, tape, or soft or hard disk, whether resident on the servers 110 and 114 or remotely accessible from web server 110 or map server 120. For example, map database 120, comprising at least one set of purchasable map data 122, may reside on such an external storage device accessible by map server 114.

Furthermore, web server 110 may have access to corporate data base 112 in order to validate the identity and account information of customers logging into the remote system 126 for the purpose of updating account information, or in order to purchase map data. Furthermore, the corporate database 112 may include registration information pertaining to each portable end user device 102 owned by the customer. Based upon this information, remote system 126 may validate both the customer and the destination device of the purchased map.

Web servers, such as web server 110, are known to those knowledgeable in the field of network communications and may include a communication module operable to send and/or receive signals and/or information to and/or from components within the customer computing device 104. For example, the communication module may include one or any combination of hardware, software, firmware, executable instructions and data to enable the transfer of communications-related signals and information over a standard HTTP, an FTP or some other data transfer protocol to an electrically connected customer computer.

Additionally, web server 110 may further include a user interface 128, i.e., web pages, to allow communication with a customer of the remote system 126. In the disclosed aspects, access to, processing of, and updating of any of the components of remote system, whether the components are resident on web server 110, map server 120 or remotely accessible by server 110 and 120, may be performed by a user in operation of such a user interface 128.

Map server 114 may comprise an application module 116 operable to generate a downloadable file 118 based upon a map file 122 previously ordered by the customer. Based upon the previously requested map part number along with user device unit information, i.e., serial number for portable end user device 102 stored in the work order generated at the time of purchase, the map server 114 is operable to build the downloadable file 118.

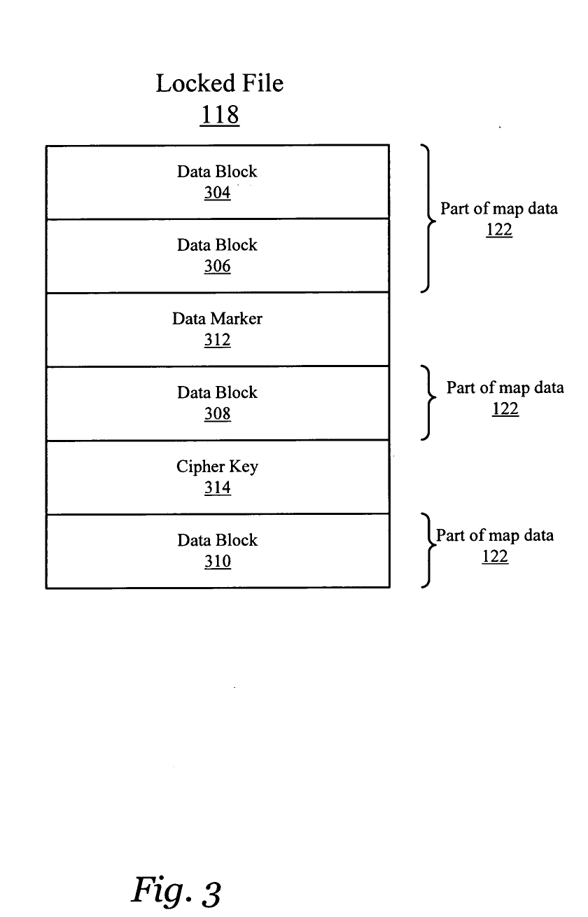

As shown in FIG. 3, the downloadable file 118 may comprise one or more data blocks, i.e., blocks 304, 306, 308, and 310, that comprise map file 122. Furthermore, the map server 114 is operable to generate a data marker 312 that when combined with the data blocks 304, 306, 308, operates to associate, or lock, the downloadable file 118 to the specific user device unit 102 stored in the purchase order.

Furthermore, the data marker 312 may be encrypted using a readily available encryption algorithm, such as BLOWFISH, to limit the ability of a user to create multiple files for multiple destination units. The encryption may be performed using either hardware or software and may generate a unique cipher key 314, operable to decrypt the data marker 312. The cipher key 314 may be hidden in file 118 at a predetermined location. In order for the end user device 102 to decrypt the file 118, the encryption algorithm, as well as the position of the cipher key in the file 118, must be known to the end user device 102 and may be stored as part of the application module 208 in the memory 206 of the portable end user device 102. Though not as secure as other known key management systems, the above method may be sufficient to discourage unauthorized tampering of the locked file 118 by all but determined hackers.

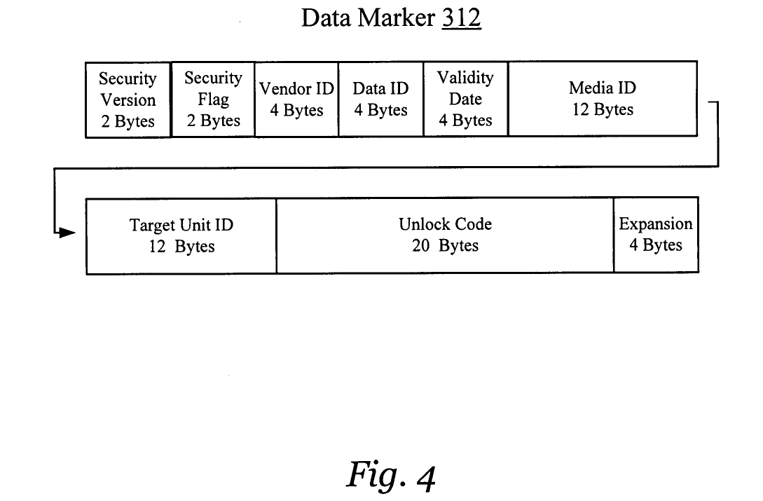

FIG. 4 provides a more detailed understanding of the data marker 312. In some embodiments, the total size of the data marker is 64 bytes. This includes 4 expansion bytes to fill the size to an integral number of 8 byte units to facilitate block encryption. In other embodiments, a data maker 312 having a different number of bytes may be used.

The data marker 312 may include a security version identifier comprising 2 bytes identifing the version of security protocol/format used in the marker 312. The security version identifying field may have a major and minor version number (1 byte each). Preferably, the security version identifier would start with 1.0.

Next, a security flag field may include 2 bytes that identify the rules by which an end user device 102 validates the data file 118. Although three rules are currently defined, the number and definition of these fields are non-limiting. These three rules include:

Rule 1. Data marker data matches an end user device identifier, i.e., end user device serial number. For example, in order for an end user device 102 to utilize the downloaded file 118, the destination unit serial number (target unit ID) stored in the data marker must match the serial number of the end user device validating the file. This rule may have variations including, but not limited to:
no checking, that is, the data is available to all end user devices;
checking only against unit serial number;
checking only against SD card ID; and
checking against both unit serial number and SD card ID.

Rule 2. Data marker data matches media ID, e.g., end user device or SD card serial number.

Rule 3. Data marker Validity Date field (to be discussed) is current, that is, the map data is inoperable if the current date is past the data marker validity date.

In addition, the data marker 312 may include a vendor ID field comprising 4 bytes. The vendor ID identifies the provider of the data. The vendor, along with a Data ID provides a unique identifier for each type/set of data provided by each vendor. If more than one vendor contributed data for a product, the vendor ID is a “virtual” ID denoting the combination.

The data ID field may comprise 4 bytes and identifies a particular type of data from a given vendor, i.e., a chart ID from a particular chart vendor and a region/CD/area ID identifying specific street data.

In addition, the data marker 312 may include a validity date field comprising 4 bytes. The validity date identifies the date that the map data becomes invalid. This feature implements a data “timeout” feature, providing data that could only be used for a specific period, i.e., one month, one year, etc. the validity date field includes the following fields:

| | |
|---|---|
| Day: | 1 byte |
| Month: | 1 byte |
| Year: | 2 bytes |

Next, a media ID comprising 12 bytes may be included that identifies the unique media that the data is to reside on, i.e., the media comprising the end user device 102. This may include information derived from the SD card identification (ID) information and may be formatted as follows:

| | |
|---|---|
| ID0 | Manufacturer's ID code. |
| ID1–ID2 | Manufacturer's name |
| ID3–ID7 | Model name |
| ID8–ID11 | Serial Number |

In addition, a target unit ID may comprise a 12 byte field consisting of end user device serial number information. The target unit ID may also be used to fill the media ID field for an end user device 102 with only internal memory.

The data marker 312 may also include an unlock code operable to unlock the map data. In some embodiments, the unlock code may comprise 20 bytes and may apply to data requiring a separate code/payment for each region/dataset.

Finally, in order to pad the data marker to a multiple of 8 bytes to facilitate encryption, an undefined expansion field of 4 bytes may be included.

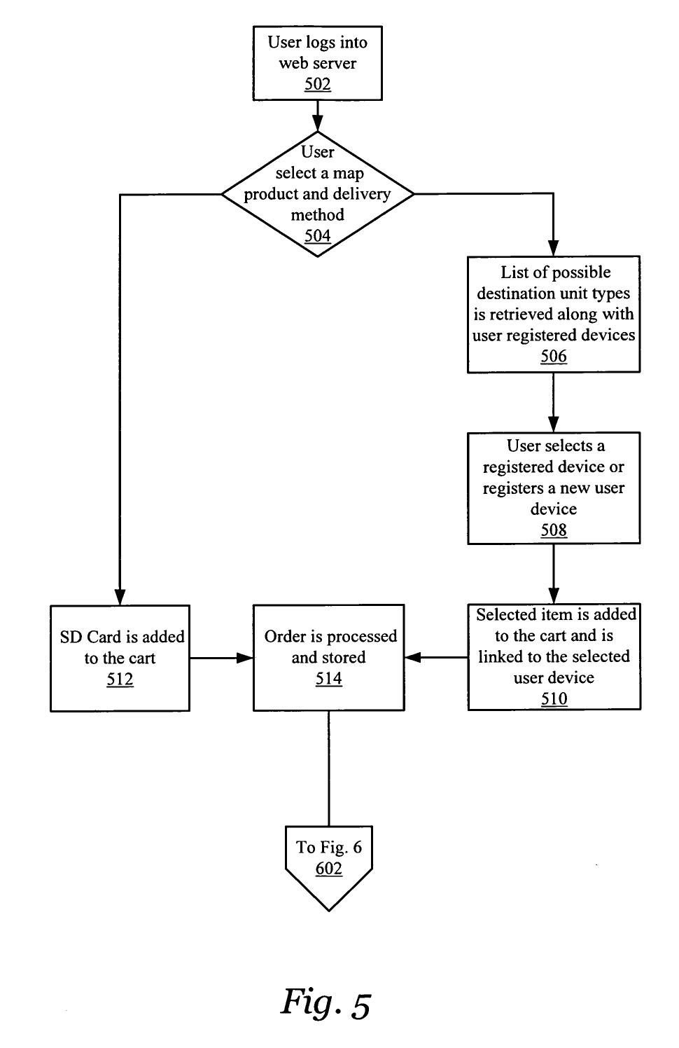

Refer now to FIG. 5, a flowchart depicting use of an embodiment according to the present invention is illustrated. In step 502, a customer logs into a web site hosted by web server 110. Logging in may include entering username and password information on the input mechanism 228 of the client computing device 104. The web server 110 validates the entered data based upon information stored in customer database 112.

Upon validating the customer, at step 504, customer may navigate to a web page that allows the customer to decide whether to download a precut map or to buy a secure digital (SD) card comprising the precut map, wherein a precut map may be considered map information, including geographic information and points of interest. If at step 504, the customer decides to buy an SD card, the SD card is added to the cart in step 512. Non-limiting, other non-map items can be added to the cart as well. At step 514, a normal order is processed and stored in the customer database 112

If at step 504 the customer decides to download the map information, at step 506, based on the type of map download, a list of possible destination unit types, i.e. portable end user device 102, is retrieved from a database, such as map database 120. In some aspects, multiple types of downloads may be available per type of destination unit selected, wherein the type of destination unit 102 may be a MAGELLAN product series like EXPLORIST or a MERIDIAN series GPS unit. For the selected destination unit type, a list of possible destination unit types is retrieved from a database and presented to the customer via the web interface 128.

Further at step 506, based upon the login information supplied by the customer, previously registered end user devices 102, stored in customer data base 112, may be presented to the customer through the web server 110.

At step 508, the customer selects a registered destination device, i.e., portable end user device 102, or alternatively, registers and selects a new destination device 102. It should be noted that the user can purchase multiple downloads at the same time, each downloadable line item in a shopping cart (not shown) is unique and should show up as a separate line item in the shopping cart (i.e., quantity can not be increased more than one).

At step 510, a link to the downloadable map information is added to the shopping cart and is tied to the registered product 102. At step 514, the order is processed and stored, and the customer may download the map information beginning on FIG. 4, step 402.

As previously disclosed, in some embodiments, a customer may purchase the requested map information on one customer computing device 104, and download the purchased file from another customer computing device 104 at a later time. According to this aspect, the customer must re-login to the remote system 126 to access their account information and download the purchased map.

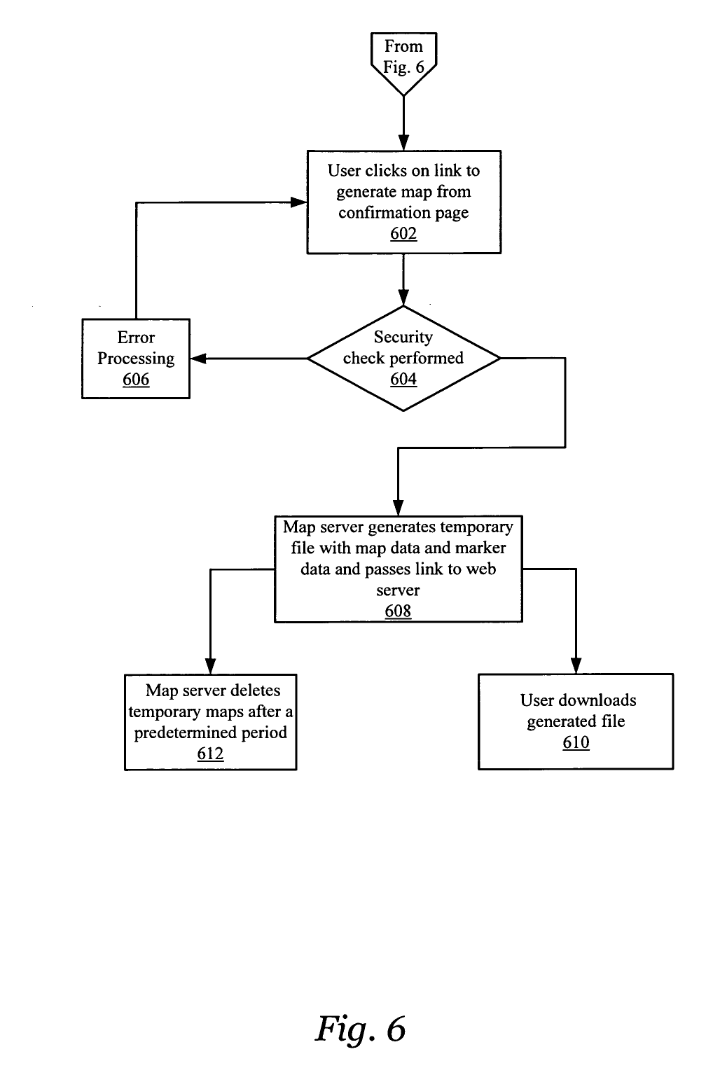

At FIG. 6, step 602, the customer clicks on the link to prepare a downloadable file 118 based upon information presented by the web server 110. Step 602 may be arrived at directly after step 514, on the same computing device as the once used during the purchasing steps, or, the user may re-login on another computing device at another time.

At step 604 a download page validates the identity of the purchaser based upon the user's account information. The download page checks the login information to determine if the person that is logged into the web server 110 is the same person that has purchased the map, and that the person that is logged into the web server 110 is the same person that has the destination unit 102 registered to their account.

At step 604, if the customer has a problem with the download or needs to repeat download, the process proceeds to step 606 that may require the customer to log back in and goes to a tracking detail for order checking. In one embodiment, a user may be requested to reattempt the download of the requested map data.

The process continues at step 608 if the customer information and purchase information is validated, i.e., the user currently logged in to the web server 20 is the owner of the destination unit 102 and is the party who has purchased the map being requested.

At step 608, the map server 114 generates a file 118 that locks the map information to the destination unit 102 and presents the user with a link to this file 118. At step 610 the customer may click on the link to download the file 118.

The file 118 may be downloaded to a memory device 218 on the customer computing device 104, such as internal or external memory, including an SD card. The computer 104 does not need the end user unit 102 to be connected in order to download the file 118.

Because retention of all such files 118 for an extended amount of time may be prohibitive, step 608 may further include a step whereby map server 114 initiates a chronological process, i.e., a map server management daemon, to delete, at step 612, a file after a set period of time.

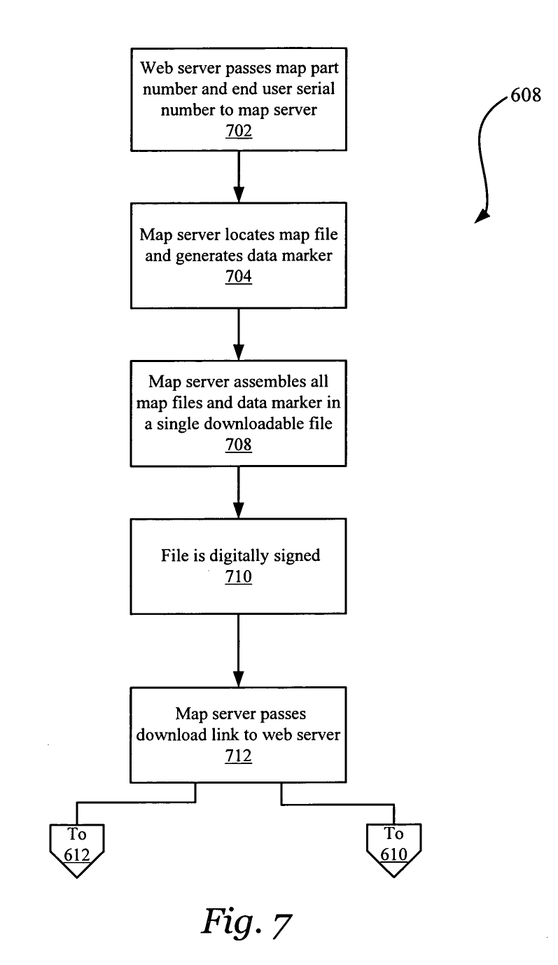

FIG. 7 is a detailed view of the method of step 608. At step 702, the web server 110 passes the part number of the requested map 122 and the serial number of the destination unit, i.e., end user device 102, to a map server 114. At step 704, the map server 114 locates the map data 122 and generates the data marker 130 as disclosed above and as shown in FIG. 4. The map server 114 encrypts the data marker and in one aspect, the cipher key 314 is included in file 118 at a predetermined location different from the data marker 312. The encryption method and the location of the cipher key are predetermined and are known to the application software module stored in the portable end user device. In other embodiments, a more robust key management protocol may be used, but would necessitate a significant increase in complexity and cost.

Because an end user device 102 is programmed to accept only those files 118 which comprise an appropriately encoded marker file 312, the map information is useable only by the end user device selected at the time of purchase. At step 740, all map related files are added to a compressed file, such as a zip file. At step 760, the zip file is digitally signed for downloading at step 780. The map server 114 passes back a download link to the web server 110, which when selected by the user, initiates the downloading of the file.

It should now be apparent that a method and system has been disclosed that permitting a customer to download maps and/or map data over a communications network for use on a predetermined portable end user device.

While the foregoing disclosure shows illustrative aspects and/or aspects, it should be noted that various changes and modifications could be made herein without departing from the scope of the described aspects and/or aspects as defined by the appended claims. Furthermore, although elements of the described aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

1. A method of securing content and destination of downloaded data, comprising the steps of:
logging a user into a remote system;
generating on the remote system a data marker including an identification number of a user device;
generating on the remote system a customized file comprising the generated data marker and a user selected information file;
providing a download link to the user; and
downloading the customized file.

2. The method of claim 1, further comprising:
checking that the logged on user has purchased the selected information file and that the user has registered the user device with the identification number provided;
encrypting the data marker and inserting a cipher key, operable to decrypt the encrypted data marker, in the customized file at a predetermined location.

3. The method of claim 1, wherein the information data is map information and the method further comprising:
presenting to the user a list of available maps based upon a selected registered user device;
retrieving a list of devices that the user has registered; and
registering a different device or choosing a previously registered device.

4. The method of claim 2, wherein the data marker is 64 bytes.

5. The method of claim 1, wherein generating a data marker comprises generating a data marker including a security version identifier, a security flag, and a validity date.

6. The method of claim 5, wherein the data marker includes an unlock code.

7. The method of claim 1, further comprising:
receiving the customized file at a computing device across a network; and
transferring the customized file from the computing device to an electrically connected GPS device.

8. The method of claim 1, wherein a portion of the data marker identifies a provider of the data and a data ID provides a unique identifier for each type/set of data from each vendor.

9. The method of claim 1, wherein a portion of the data marker identifies a particular type of data from a given vendor.

10. The method of claim 1, wherein a portion of the data marker identifies a date the data marker becomes invalid.

11. The method of claim 1, wherein a portion of the data marker identifies a unique media that the customized file is meant to reside on.

12. The method of claim 11, wherein the portion of the data maker which identifies the unique media would either be derived from a secure digital (SD) card ID or the end user device identification number.

13. At least one processor configured to perform the actions of:
logging a user into a remote system comprising a map server;
generating on the map server a data marker including an end user device identification number for the end user device;
generating on the map server a customized file comprising the generated data marker and a user selected map file;
providing a download link for the user; and
downloading the customized file.

14. A method of securing content and destination of downloaded data, comprising the steps of:
receiving on a portable end user device a customized file from a computing device across a network, the customized file comprising user selected information and a data marker including information pertaining to a specific end user device;
comparing the information stored in the data marker block with at least a serial number of the end user device; and
utilizing the user selected information on the end user device based upon a result of the comparison.

15. The method of claim 14, further comprising:
extracting a cipher key from a predetermined location within the customized file; and
decrypting the data marker using the extracted cipher key.

16. The method of claim 14, wherein comparing information stored in a data marker within the customized file includes comparing a serial number of the end user device with a target Unit ID field of the data marker.

17. The method of claim 14, wherein utilizing the user selected information on the end user device is based upon a set of rules specified in the data marker.

18. A portable GPS device configured to perform the actions of:
receiving a customized map file from a computing device, the map file comprising map information;
comparing information stored in a data marker block of the customized map file with at least a serial number of the GPS device in order to determine that the received customized map file is intended for the GPS device receiving the map; and
displaying the map information on the GPS device based upon a result of the comparison.
